(19) United States
(12) Patent Application Publication
(10) Pub. No.: US 2026/0291423 A1
(43) Pub. Date: Sep. 24, 2026

(54) MOTOR DRIVING APPARATUS AND METHOD OF CONTROLLING SAME

(71) Applicants: Hyundai Motor Company, Seoul (KR); Kia Corporation, Seoul (KR)

(72) Inventors: Joon Ha HWANG, Hwaseong-Si (KR); Hee Won AN, Hwaseong-Si (KR); Seong Min KIM, Hwaseong-Si (KR); Ho Sun JANG, Hwaseong-Si (KR)

(73) Assignees: Hyundai Motor Company, Seoul (KR); Kia Corporation, Seoul (KR)

(21) Appl. No.: 19/305,470

(22) Filed: Aug. 20, 2025

(30) Foreign Application Priority Data
Mar. 19, 2025 (KR) 10-2025-0035367

(51) Int. Cl. H02P 29/60; H02P 23/00; H02P 23/02; H02P 27/08

(52) U.S. Cl. CPC H02P 29/60; H02P 23/0027; H02P 23/02; H02P 27/08

(57) ABSTRACT

Provided are a motor driving apparatus and a method of controlling same, wherein the apparatus includes a first inverter, a second inverter, a plurality of third switching elements, each having one end connected to a corresponding second end of one, different from one another, of the plurality of windings, and an opposite end interconnected with an opposite end of each of remaining third switching elements, and a controller configured to drive the motor in either a first driving mode or a second driving mode based on a motor's Back EMF value, a torque command, and a motor temperature, wherein, as necessary, the plurality of third switching elements is configured such that, when turned on, the first switching elements are controlled to drive the motor, or when turned off, both the first switching elements and the second switching elements are controlled to drive the motor.

### CROSS REFERENCE TO RELATED APPLICATION

The present application claims priority to Korean Patent Application No. 10- 2025- 0035367, filed Mar. 19, 2025, the entire contents of which are incorporated herein for all purposes by this reference.

### TECHNICAL FIELD

Field of the Present Disclosure Embodiments of the present disclosure relate to a motor driving apparatus and a method of controlling same, capable of efficiently driving a motor while taking its temperature into account.

### BACKGROUND

Typically, a winding of each phase in a motor has one end connected to one inverter and an opposite end connected to opposite ends of windings of other phases, forming a Y-connection.

When the motor is driven, switching elements inside the inverter are turned on and off by pulse width modulation control, applying the line voltage to the windings of the Y-connected motor to generate alternating current, thereby generating torque.

The fuel efficiency (or electric power efficiency) of eco-friendly vehicles such as electric vehicles that use the torque generated by such motors as power is determined by the power conversion efficiency of the inverter-motor. Therefore, in order to improve fuel efficiency, it is important to maximize the power conversion efficiency of the inverter and the efficiency of the motor.

The efficiency of an inverter-motor system is primarily determined by the voltage utilization rate of the inverter. When a vehicle's operating point, determined by the relationship between motor speed and torque, is established in a section with a high voltage utilization rate, the vehicle's fuel efficiency may be improved.

However, as the number of motor windings increases to increase the maximum torque of the motor, the section with high voltage utilization becomes farther away from the low torque area, which is the main operating point of the vehicle, and this may reduce fuel efficiency. In addition, when the main operating point is designed to be included in the section with high voltage utilization from the perspective of fuel efficiency, the vehicle's launching performance may be limited.

Accordingly, in the related art, a technology has been introduced to drive a single motor in two distinct modes using two inverters and split switches. This approach increases voltage utilization at key operating points, thereby improving fuel efficiency while simultaneously generating high maximum torque.

The foregoing is intended merely to aid in the understanding of the background of the present disclosure and is not intended to mean that the present disclosure falls within the purview of the related art that is already known to those skilled in the art.

### SUMMARY

Embodiments of the present disclosure are intended to provide a motor driving apparatus and a method of controlling the motor driving apparatus and capable of efficiently driving a motor by appropriately selecting one of two driving modes, where a motor winding is either Y-connected or open, based on the motor's temperature.

The technical aspects to be achieved in the embodiments of the present disclosure are not limited to those mentioned above, and other technical aspects not mentioned will be clearly understood by a person having ordinary skill in the technical field to which the present disclosure belongs from the description below.

In order to achieve the above objective, a motor driving apparatus for driving a motor having a plurality of windings corresponding to a plurality of phases may be provided as a means according to a disclosed embodiment, the apparatus comprising: a first inverter including a plurality of first switching elements and connected to first ends of the plurality of windings, a second inverter including a plurality of second switching elements connected to second ends of the plurality of windings, a plurality of third switching elements having first ends connected to a second end of each of the plurality of windings and second ends connected to each other and a controller operatively connected to the first inverter, the second inverter and the plurality of third switching elements and configured to drive the motor in either a first driving mode or a second driving mode based on a motor's Back ElectroMotive Force (EMF) value, a torque command and a motor temperature, wherein, in the first driving mode, the plurality of third switching elements are turned on, and the first switching elements are controlled by the controller to drive the motor, and wherein, in the second driving mode, the plurality of third switching elements are turned off, and both the first switching elements and the second switching elements are controlled by the controller to drive the motor.

In the disclosed embodiment, the controller may be configured to determine either the first driving mode or the second driving mode based on a map selected from a plurality of maps, each map having predefined driving modes, and wherein each of the driving modes is determined based on the motor's Back EMF value and the corresponding torque command.

In the disclosed embodiment, each of the plurality of maps may correspond to a temperature range, different from one another.

In the disclosed embodiment, the controller may be configured to determine either the first driving mode or the second driving mode from the plurality of maps based on the map corresponding to a motor temperature range that includes the motor temperature.

In the disclosed embodiment, each of the plurality of maps may have a first axis corresponding to the motor’s Back EMF value and a second axis corresponding to the torque command, and wherein each of the plurality of maps may comprise a first region for the first driving mode and a second region for the second driving mode, defined within a region bounded by the first and second axes.

In the disclosed embodiment, among the plurality of maps, a map corresponding to a higher motor temperature range may have the second region that is more expanded than that of a map corresponding to a lower motor temperature range.

In the disclosed embodiment, the plurality of maps may be set based on a current rating of the plurality of third switching elements.

In the disclosed embodiment, each of the plurality of maps may correspond to the second driving mode when the torque command for the motor is greater than a limit torque for the first driving mode determined based on the current rating of the plurality of third switching elements.

In the disclosed embodiment, the controller may be configured to determine the motor's Back EMF value based on a voltage of the battery, which is configured to store power for the motor and the motor's rotation speed.

According to another embodiment, a motor driving apparatus for driving a motor having a plurality of windings corresponding to a plurality of phase may be provided as another means to achieve the above objective, the apparatus comprising: a first inverter including a plurality of first switching elements and connected to first ends of the plurality of windings, a second inverter including a plurality of second switching elements connected to second ends of the plurality of windings, a plurality of third switching elements having first ends connected to a second end of each of the plurality of windings and second ends connected to each other and a controller configured to drive the motor by controlling states of each of the plurality of first, second, and third switching elements, wherein the first, second and third switching elements are each controlled by the controller with reference to a map that corresponds to a motor temperature and is selected from a plurality of maps prepared in advance, as well as based on a motor's Back EMF value and a torque command. In another disclosed embodiment, the controller may be configured to drive the motor in either a first driving mode or a second driving mode, wherein the motor is driven with reference to a map corresponding to the motor temperature, as well as based on the motor's Back EMF value and the torque command, wherein, in the first driving mode, the plurality of third switching elements are turned on, and the first switching elements are controlled by the controller to drive the motor, whereas, in the second driving mode, the plurality of third switching elements are turned off, and both the first switching elements and the second switching elements are controlled by the controller to drive the motor.

In another disclosed embodiment, each of the plurality of maps may correspond to a temperature range, different from one another.

In another disclosed embodiment, the controller may be configured to determine either the first driving mode or the second driving mode from the plurality of maps based on the map corresponding to a motor temperature range that includes the motor temperature.

In another disclosed embodiment, each of the plurality of maps, having a first axis corresponding to the motor’s Back EMF value and a second axis corresponding to the torque command, may include a first region for the first driving mode and a second region for the second driving mode, defined within the region bounded by the first and second axes, wherein, among the plurality of maps, a map corresponding to a higher motor temperature range has the second region that is more expanded than that of a map corresponding to a lower motor temperature range.

In another disclosed embodiment, the plurality of maps may be set based on a current rating of the plurality of third switching elements.

In another disclosed embodiment, each of the plurality of maps may have the region divided into the first region and the second region based on a torque generated with a current that reaches the current rating of the plurality of third switching elements within the corresponding motor temperature range.

In another disclosed embodiment, the controller may be configured to determine the motor’s Back EMF value based on a voltage of the battery, which is configured to store power for the motor and the motor’s rotation speed.

According to still another disclosed embodiment, there may be provided a method for controlling a motor driving apparatus configured to drive the motor through: a first inverter, which includes a plurality of first switching elements and to which a first end of each of a plurality of windings corresponding to a plurality of phases of a motor is independently connected; a second inverter, which includes a plurality of second switching elements and to which a second end of each of the plurality of windings is independently connected; and a plurality of third switching elements, each having one end connected to the corresponding second end of one, different from one another, of the plurality of windings, and an opposite end interconnected with an opposite end of each of remaining third switching elements, the method including: determining a map corresponding to a motor temperature from a plurality of maps, each corresponding to a specific temperature range and having predefined driving modes, wherein each of the driving modes is defined in association with a motor's Back EMF value and a corresponding torque command; and driving the motor in either a first or second driving mode, wherein the motor is driven with reference to the determined map as well as on the basis of the motor's Back EMF value and the torque command, wherein, in the first driving mode, the plurality of third switching elements is turned on, and the first switching elements are controlled to drive the motor, whereas, in the second driving mode, the plurality of third switching elements is turned off, and both the first switching elements and the second switching elements are controlled to drive the motor.

As described above, according to the disclosed embodiments of the present disclosure, the Y-connected motor driving mode operation range may be expanded by driving the motor by applying different maps based on the motor temperature of the motor driving apparatus, thereby further increasing the efficiency of the motor.

The effects that may be obtained in the embodiments of the present disclosure are not limited to the effects mentioned above, and other effects that are not mentioned will be clearly understood by those skilled in the art to which the present disclosure belongs from the description below.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a circuit diagram illustrating an example of a motor driving apparatus that includes a first inverter, a second inverter, a split switches, a motor, and a controller for controlling them, according to one embodiment;

FIG. 2 is a graph illustrating a limited motor output for each driving mode as a function of motor speed when the motor driving apparatus, according to one embodiment, operates in either a first or a second driving mode;

FIG. 3 is a graph illustrating a limited motor torque for each driving mode as a function of motor speed when the motor driving apparatus, according to one embodiment, operates in either the first or the second driving mode;

FIG. 4 illustrates an example map that indicates driving modes corresponding to a torque command and a motor’s Back EMF value, according to one embodiment, based on a motor temperature of T1;

FIG. 5 illustrates an example map that indicates driving modes corresponding to a torque command and a motor’s Back EMF value, according to one embodiment, based on a motor temperature of T2;

FIG. 6 illustrates an example map that indicates driving modes corresponding to a torque command and a motor’s Back EMF value, according to one embodiment, based on a motor temperature of T3;

FIG. 7 illustrates an example map that indicates driving modes corresponding to a torque command and a motor’s Back EMF value, according to one embodiment, based on a motor temperature of T4; and

FIG. 8 is a flowchart illustrating an example process for controlling a motor by determining one of driving modes based on an acquired motor temperature within the controller, according to one embodiment.

### DETAILED DESCRIPTION OF THE DISCLOSURE

Hereinafter, embodiments disclosed in the present specification will be described in detail with reference to the accompanying drawings, but the same or similar components are assigned the same reference numerals regardless of reference numerals, and overlapping descriptions thereof will be omitted. The terms "module" and "part" for the components used in the following description are given or mixed in consideration of only the ease of writing the specification and do not have distinct meanings or roles by themselves. In addition, in describing the embodiments disclosed in the present specification, when it is determined that detailed descriptions of related known technologies may obfuscate the gist of the embodiments disclosed in the present specification, the detailed description thereof will be omitted. In addition, the accompanying drawings are only to aid in easy understanding of the embodiments disclosed in this specification, and the technical idea disclosed herein is not limited by the accompanying drawings, and all changes included in the spirit and scope of the present disclosure should be understood to include equivalents or substitutes.

Terms including ordinal numbers such as first, second, and the like may be used to describe various elements, but the elements are not limited by the terms. The above terms are used only for the purpose of distinguishing one component from another.

When a component is referred to as being “connected” or “coupled” to another component, it may be directly connected or coupled to another component, but it should be understood that other components may exist in between. On the other hand, when a component is referred to as being "directly connected" or "directly connected" to another component, it should be understood that there are no other components in between.

A singular expression includes a plural expression unless the context clearly dictates otherwise.

In the present specification, terms such as "comprises" or "have" are intended to designate that the features, numbers, steps, operations, components, parts, or combinations thereof described in the specification exist and should be understood that it does not preclude the possibility of addition or existence of one or more other features, numbers, steps, operations, components, parts, or combinations thereof.

In addition, a unit or a control unit included in the name of the motor controller unit (MCU) and the like is a term widely used to name a control device (controller) that controls a specific function of a vehicle and does not mean a generic function unit. For example, each controller may include a communication device that communicates with other controllers or sensors to control the function in charge, a memory that stores an operating system or logic commands and input/output information, and one or more processors that perform determination, calculation, and decision, and the like necessary for controlling the function in charge.

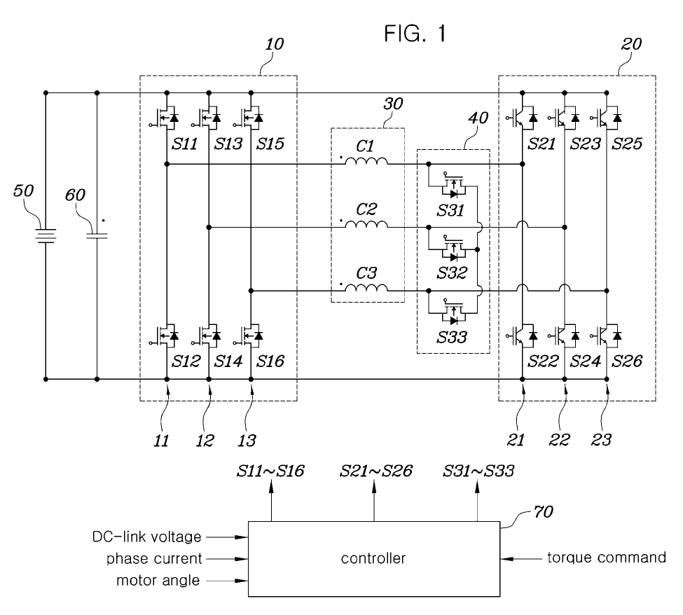

FIG. 1 is a circuit diagram illustrating an example of a motor driving apparatus that includes a first inverter, a second inverter, split switches, a motor, and a controller for controlling them, according to one embodiment.

With reference to FIG. 1, the motor driving apparatus according to one embodiment may include a first inverter 10, a second inverter 20, a motor 30 having a plurality of windings C1, C2, and C3 each corresponding to a respective phase, split switches 40, a battery 50, a DC capacitor (or DC-link capacitor) 60, and a controller 70.

The first inverter 10 may include a plurality of first switching elements S11, S12, S13, S14, S15, and S16, each pair of which is connected to a corresponding one end of the plurality of windings C1, C2, and C3 and the second inverter 20 may include a plurality of second switching elements S21, S22, S23, S24, S25, and S26, each pair of which is connected to a corresponding opposite end of one of the plurality of windings C1, C2, and C3. The split switches 40 may include a plurality of third switching elements S31, S32, and S33, each of which is connected between a corresponding opposite end of one of the plurality of windings C1, C2, and C3 and a neutral end of the plurality of windings C1, C2, and C3. The controller 70 may control the on/off states of the first switching elements S11, S12, S13, S14, S15, and S16, the second switching elements S21, S22, S23, S24, S25, and S26, and the third switching elements S31, S32, and S33 based on the motor torque command, the DC-link voltage of the first and second inverters 10 and 20 (that is, the battery voltage), the phase current of the motor, and the motor angle.

The first inverter 10 may include a plurality of legs 11, 12, and 13 to which a DC voltage provided in a DC capacitor 60 connected between the two opposite ends of the battery 50 is applied. The legs 11, 12, and 13 may each be electrically connected to a corresponding phase of the motor 30.

More specifically, the first leg 11 includes two switching elements S11 and S12 connected in series between the two opposite ends of the DC capacitor 60, and a connection node of the two switching elements S11 and S12 may be connected to one end of the winding C1 of one phase in the motor 30, so that AC power corresponding to one of the plurality of phases may be input/output. Similarly, the second leg 12 includes two switching elements S13 and S14 connected in series between the two opposite ends of the DC capacitor 60, and a connection node of the two switching elements S13 and S14 may be connected to one end of the winding C2 of one phase in the motor 30, so that AC power corresponding to one of the plurality of phases may be input/output. In addition, the third leg 13 includes two switching elements S15 and S16 connected in series between the two opposite ends of the DC capacitor 60, and a connection node of the two switching elements S15 and S16 may be connected to one end of the winding C3 of one phase in the motor 30, so that AC power corresponding to one of the plurality of phases may be input/output.

The second inverter 20 may include a plurality of legs 21, 22, and 23 to which the DC voltage provided in the DC capacitor 60 connected between the two opposite ends of the battery 50 is applied. The legs 21, 22, and 23 may each be electrically connected to a corresponding phase of the motor 30.

More specifically, the first leg 21 includes two switching elements S21 and S22 connected in series between the two opposite ends of the DC capacitor 60, and a connection node of the two switching elements S21 and S22 may be connected to one opposite end of the winding C1 of one phase in the motor 30, so that AC power corresponding to one of the plurality of phases may be input/output. Similarly, the second leg 22 includes two switching elements S23 and S24 connected in series between the two opposite ends of the DC capacitor 60, and a connection node of the two switching elements S23 and S24 may be connected to one opposite end of the winding C2 of one phase in the motor 30, so that AC power corresponding to one of the plurality of phases may be input/output. In addition, the third leg 23 includes two switching elements S25 and S26 connected in series between the two opposite ends of the DC capacitor 60, and a connection node of the two switching elements S25 and S26 may be connected to one opposite end of the winding C3 of one phase in the motor 30, so that AC power corresponding to one of the plurality of phases may be input/output.

The plurality of third switching elements S31, S32, and S33, each having one end connected to the corresponding opposite end of one of the plurality of windings C1, C2, and C3 included in the motor 30 and one opposite end interconnected with an opposite end of each of remaining third switching elements at the neutral end of the motor 30. The plurality of the third switching elements S31, S32, and S33 may adopt various switching means known in the related art, such as MOSFETs, IGBTs, thyristors, relays, and the like.

Although not shown in FIG. 1, the motor driving apparatus may further include a so-called Y-capacitor (Y-Cap) which has two capacitors connected in series between a positive (+) DC terminal and negative (-) DC terminal, wherein a connection node between the capacitors is grounded.

The controller 70 may control the motor 30 to drive by switching the switching elements S11, S12, S13, S14, S15, S16, S21, S22, S23, S24, S25, and S26 included in the first inverter 10 and the second inverter 20 through Pulse Width Modulation(PWM) control based on the torque command required for the motor 30.

In addition, the controller 70 may control the on/off state of the third switching elements S31, S32, and S33 included in the split switches 40, according to a motor driving mode. The motor driving mode may include a first driving mode and a second driving mode. At this time, the first driving mode may be referred to a “Closed End Winding (CEW) mode”, and the second driving mode may be referred to an “Open End Winding (OEW) mode”.

More specifically, when driving the motor 30 in the CEW mode, the controller 70 may control the third switching elements S31, S32, and S33 to switch to an ON state and drive the motor 30 through the first inverter 10 of the two inverters, 10 and 20. The third switching elements S31, S32, and S33 may electrically connect the corresponding opposite end of each of the plurality of windings C1, C2 and C3 and the neutral end of the plurality of windings C1, C2 and C3 when in an ON state.

Unlike this, when driving the motor 30 in the OEW mode, the controller 70 may control the third switching elements S31, S32, and S33 to switch to an OFF state and drive the motor 30 through two inverters 10 and 20. The third switching elements S31, S32, and S33 may each, when in an OFF state, electrically separate the corresponding opposite connection node of one of the plurality of windings, C1, C2 and C3, from the neutral end of the plurality of windings C1, C2 and C3.

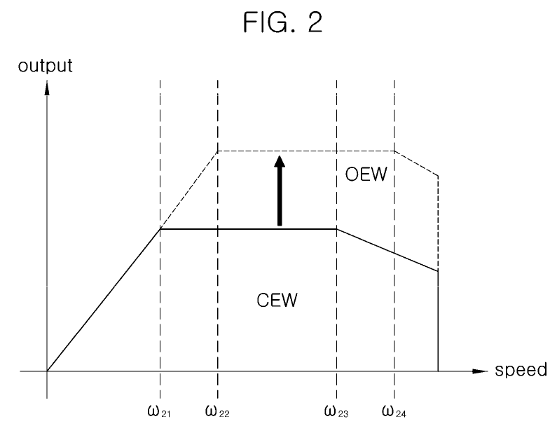

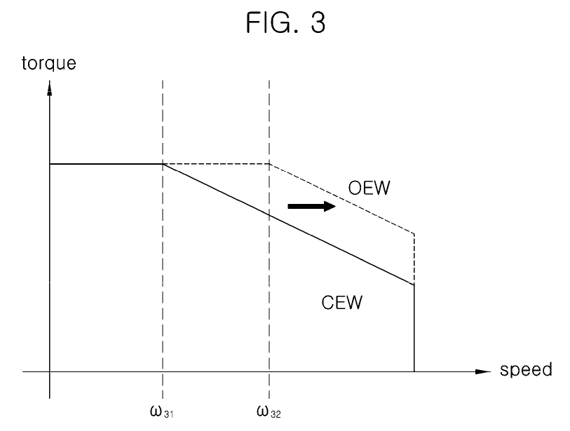

FIGS. 2 and 3 are graphs illustrating a limited motor output and a limited motor torque, respectively, for each driving mode as a function of motor speed when the motor driving apparatus, according to one embodiment, operates in either a first or a second driving mode;

With reference to FIG. 2, when the motor 30 is driven in the CEW mode, in the section where the motor 30 operates at a low speed (that is, below ω21), the output may also increase as the motor speed increases. However, when the motor speed is above a certain speed ω21, the motor output may no longer increase even though the motor speed increases. Furthermore, when the motor 30 is driven at a high speed (no less than ω23), the output may practically decrease as the motor speed increases. On the other hand, the same phenomenon occurs when the motor 30 is driven in the OEW mode, but a higher maximum output may be reached compared to the CEW mode (in the section no less than ω22 but less than ω24).

With reference to FIG. 3, when the motor 30 is driven in CEW mode, it may generate a constant torque at a low speed (below ω31), but at a high speed (above ω31), the torque may conversely decrease as the motor speed increases. Meanwhile, when the motor 30 is driven in the OEW mode, the area in which the motor 30 may produce maximum torque (area below ω32) may be expanded compared to the CEW mode (area below ω31).

To summarize the contents of the graphs in FIGS. 2 and 3, it is necessary to operate the motor (30) in the OEW mode when the motor's operating point, determined by its speed and torque command, lies in a high-torque, high-output region. However, in the range of low torque and low power, the CEW mode may achieve higher efficiency than the OEW mode. Therefore, to achieve high motor efficiency while generating large power, switching between the two modes is necessary based on the torque command and motor speed.

The controller 70 inside the motor driving apparatus may determine the Back EMF value by considering the DC-link voltage of the motor and the motor speed, and may determine the driving mode based on the Back EMF value and the torque command. At this time, the controller 70 may determine the driving mode based on a pre-prepared map. This may be a 2D map where the first axis represents the Back EMF value, and the second axis represents the torque command. Each spot on the map, defined by the Back EMF value and the torque command, may be corresponding to either the OEW mode or the CEW mode. In addition, since the third switching elements S31, S32, and S33 in the split switches 40 may have a current specification, which refers to a limiting current value for normal operation, the map may be created considering such current specifications.

Heat is generated by iron loss, copper loss, and friction when the motor 30 is driven, so the temperature of the motor may change from time to time. The magnetic properties of the motor change as its temperature changes, so it may be necessary to take motor temperature into account when creating the map to determine the driving mode.

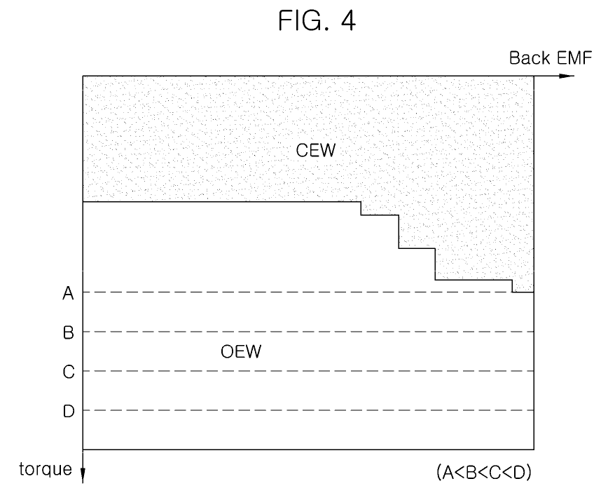

Herein after, with reference to FIGS. 4-7, a plurality of maps corresponding to different temperature ranges according to the embodiment are described.

FIGS. 4-7 respectively illustrate example maps that indicate driving modes corresponding to torque commands and the motor’s Back EMF values, according to one embodiment of the present disclosure, at motor temperatures T1, T2 (lower than T1), T3 (lower than T2), and T4 (lower than T3). That is, each map shown in FIGS. 4-7 corresponds to a temperature range, where the upper limit is the motor temperature corresponding to the respective figure. For example, FIG. 4, which is based on the motor temperature of T1, may correspond to a temperature range where the motor temperature exceeds T2 but does not exceed T1.

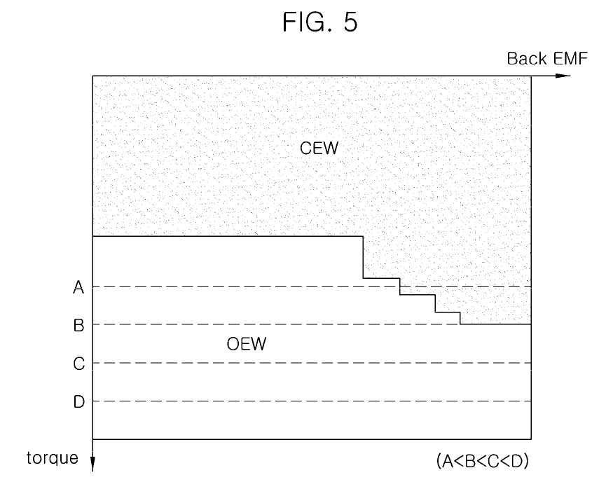

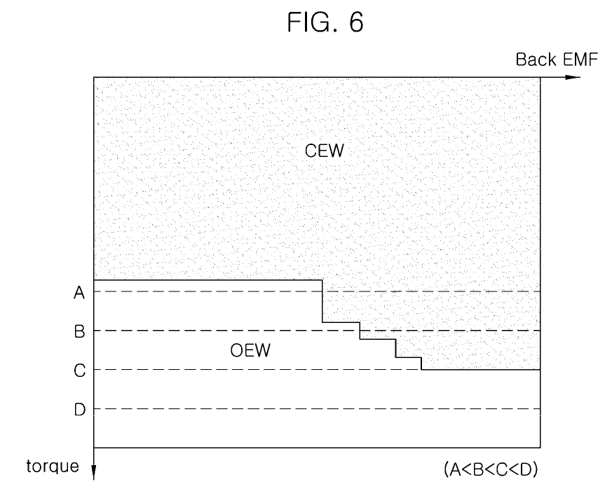

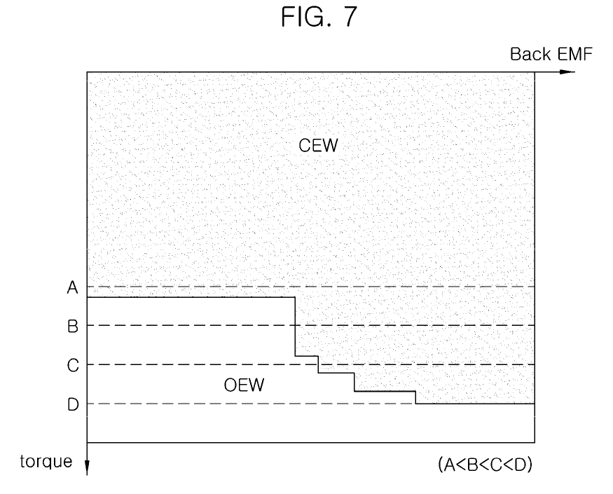

With reference to FIGS. 4-7, as the motor temperature decreases, the area occupied by the CEW mode in the map may expand. In FIG. 4, the maximum torque (limit torque) obtainable in the CEW mode corresponds to point A; in FIG. 5, to point B; in FIG. 6, to point C; and in FIG. 7, to point D. One reason for this is that as the temperature increases, the magnetic flux generated by the permanent magnets inside the motor weakens.

Therefore, when the driving mode is determined based on a plurality of maps created by considering various motor temperatures, the area in which the motor operates in the CEW mode may expand compared to when the driving mode is determined based on a single map created by considering a high motor temperature (T1 in the case of FIG. 4), thereby increasing motor efficiency.

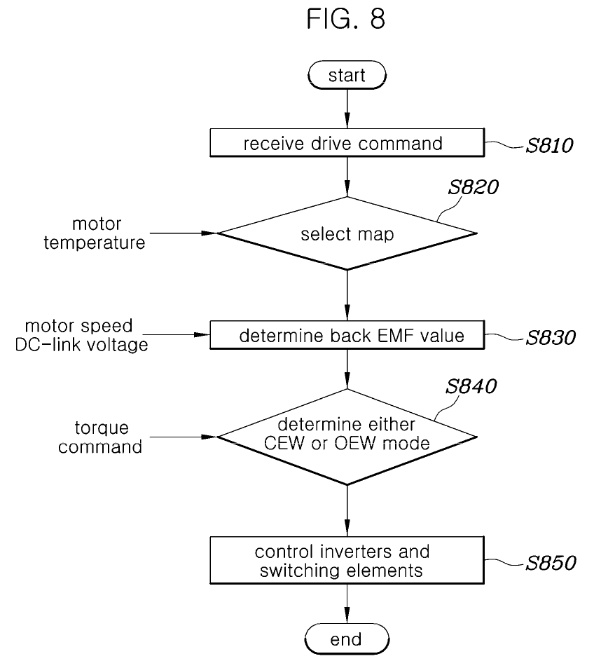

FIG. 8 is a flowchart illustrating an example process for controlling a motor by determining one of driving modes based on an acquired motor temperature within the controller, according to one embodiment.

With reference to FIG. 8, the controller 70, upon receiving a drive command in S810, may, in S820, obtain the motor temperature from a temperature sensor (not shown) and select, from the plurality of maps, the one corresponding to the temperature range that includes the motor temperature. Based on the selected map from the plurality of maps, the driving mode may be determined in S840. This driving mode corresponds to the Back EMF value, which is determined in S830 using the motor speed and DC-link voltage, and the torque command. Accordingly, when it is determined to operate in the CEW mode, the controller 70 may, in S850, turn on the third switching elements S31, S32, and S33 and drive the motor 30 using only the first inverter 10 from the two inverters, 10 and 20. On the contrary, when it is determined to operate in the OEW mode, the controller 70 may, in S850, turn off the third switching elements S31, S32, and S33 and drive the motor 30 using both inverters, 10 and 20.

As described above, in one embodiment, the motor driving apparatus may obtain the motor temperature from the temperature sensor and determine the driving mode as either the CEW mode or the OEW mode, based on the map, among a plurality of maps, that corresponds to the temperature range including the motor temperature, thereby efficiently driving the motor. This allows for further improvement in motor efficiency by expanding the area operated/operating range/driving area in the CEW mode. In addition, in the above embodiments, the map referred to in determining the driving mode of the motor assumes that the first axis corresponds to the Back EMF and the second axis corresponds to the torque command, but this is exemplary and is not necessarily limited thereto. As another example, by setting the first axis to represent motor speed (RPM) and the second axis to represent the torque command, the map may be used to define driving modes for each operating point.

While the present disclosure has been described and illustrated with respect to specific embodiments, it will be apparent to those skilled in the art that the present disclosure may be improved or modified in various ways without departing from its technical spirit, as defined by the following claims.

What is claimed is:

1. A motor driving apparatus for driving a motor having a plurality of windings corresponding to a plurality of phases, the apparatus comprising:
a first inverter including a plurality of first switching elements and connected to first ends of the plurality of windings;
a second inverter including a plurality of second switching elements connected to second ends of the plurality of windings; and
a plurality of third switching elements having first ends connected to a second end of each of the plurality of windings and second ends connected to each other;
a controller operatively connected to the first inverter, the second inverter and the plurality of third switching elements and configured to drive the motor in either a first driving mode or a second driving mode based on the motor's Back ElectroMotive Force (EMF) value, a torque command and a motor temperature,
wherein, in the first driving mode, the plurality of third switching elements are turned on, and the first switching elements are controlled by the controller to drive the motor, and
wherein, in the second driving mode, the plurality of third switching elements are turned off, and both the first switching elements and the second switching elements are controlled by the controller to drive the motor.

2. The apparatus of claim 1, wherein the controller is further configured to determine either the first driving mode or the second driving mode based on a map selected from a plurality of maps, each map having predefined driving modes, and
wherein each of the driving modes is determined based on the motor's Back EMF value and the corresponding torque command.

3. The apparatus of claim 2, wherein each of the plurality of maps corresponds to a temperature range, different from one another.

4. The apparatus of claim 3, wherein the controller is further configured to determine either the first driving mode or the second driving mode from the plurality of maps based on the map corresponding to a motor temperature range that includes the motor temperature.

5. The apparatus of claim 3,
wherein each of the plurality of maps has a first axis corresponding to the motor’s Back EMF value and a second axis corresponding to the torque command, and
wherein each of the plurality of maps comprises a first region for the first driving mode and a second region for the second driving mode, defined within a region bounded by the first and second axes.

6. The apparatus of claim 5, wherein, among the plurality of maps, a map corresponding to a higher motor temperature range has the second region that is more expanded than that of a map corresponding to a lower motor temperature range.

7. The apparatus of claim 3, wherein the plurality of maps is set based on a current rating of the plurality of third switching elements.

8. The apparatus of claim 7, wherein each of the plurality of maps corresponds to the second driving mode when the torque command for the motor is greater than a limit torque for the first driving mode determined based on the current rating of the plurality of third switching elements.

9. The apparatus of claim 1, wherein the controller is further configured to determine the motor's Back EMF value based on a voltage of a battery, which is configured to store power for the motor and the motor's rotation speed.

10. A motor driving apparatus for driving a motor having a plurality of windings corresponding to a plurality of phases, the apparatus comprising:
a first inverter including a plurality of first switching elements and connected to first ends of the plurality of windings;
a second inverter including a plurality of second switching elements connected to second ends of the plurality of windings;
a plurality of third switching elements having first ends connected to a second end of each of the plurality of windings and second ends connected to each other; and
a controller operatively connected to the first inverter, the second inverter and the plurality of third switching elements and configured and configured to drive the motor by controlling states of each of the plurality of first, second, and third switching elements,
wherein the first, second and third switching elements are each controlled by the controller with reference to a map that corresponds to a motor temperature and is selected from a plurality of maps prepared in advance, as well as based on the motor's Back EMF value and a torque command.

11. The apparatus of claim 10,
wherein the controller is further configured to drive the motor in either a first driving mode or a second driving mode,
wherein the motor is driven with reference to a map corresponding to the motor temperature, as well as based on the motor's Back EMF value and the torque command, and
wherein, in the first driving mode, the plurality of third switching elements are turned on, and the first switching elements are controlled by the controller to drive the motor, and
wherein, in the second driving mode, the plurality of third switching elements are turned off, and both the first switching elements and the second switching elements are controlled by the controller to drive the motor.

12. The apparatus of claim 11, wherein each of the plurality of maps corresponds to a temperature range, different from one another.

13. The apparatus of claim 12, wherein the controller is further configured to determine either the first driving mode or the second driving mode from the plurality of maps based on a map corresponding to a motor temperature range that includes the motor temperature.

14. The apparatus of claim 13,
wherein each of the plurality of maps, having a first axis corresponding to the motor’s Back EMF value and a second axis corresponding to the torque command, comprises a first region for the first driving mode and a second region for the second driving mode, defined within a region bounded by the first and second axes, and
wherein, among the plurality of maps, a map corresponding to a higher motor temperature range has the second region that is more expanded than that of a map corresponding to a lower motor temperature range.

15. The apparatus of claim 14, wherein the plurality of maps is set based on a current rating of the plurality of third switching elements.

16. The apparatus of claim 15, wherein each of the plurality of maps has the region divided into the first region and the second region based on a torque generated with a current that reaches the current rating of the plurality of third switching elements within a corresponding motor temperature range.

17. The apparatus of claim 10, wherein the controller is further configured to determine the motor’s Back EMF value based on a voltage of a battery, which is configured to store power for the motor and the motor’s rotation speed.

18. A method for controlling a motor driving apparatus configured to drive a motor through a first inverter, which includes a plurality of first switching elements and to which a first end of each of a plurality of windings corresponding to a plurality of phases of a motor is independently connected, a second inverter, which includes a plurality of second switching elements and to which a second end of each of the plurality of windings is independently connected, and a plurality of third switching elements, each having one end connected to the corresponding second end of one, different from one another, of the plurality of windings, and an opposite end interconnected with an opposite end of each of remaining third switching elements, the method comprising:
determining a map corresponding to a motor temperature from a plurality of maps, each corresponding to a predetermined temperature range and having predefined driving modes, wherein each of the driving modes is defined in association with the motor's Back EMF value and a corresponding torque command; and
driving the motor in either a first driving mode or a second driving mode of the predefined driving modes, wherein the motor is driven with reference to the determined map as well as based on the motor's Back EMF value and the torque command,
wherein, in the first driving mode, the plurality of third switching elements is turned on, and the first switching elements are controlled, by a controller, to drive the motor, and
wherein, in the second driving mode, the plurality of third switching elements is turned off, and both the first switching elements and the second switching elements are controlled, by the controller, to drive the motor.

19. The method of claim 18, wherein the plurality of maps is set based on a current rating of the plurality of third switching elements.

20. The method of claim 19, wherein each of the plurality of maps has a region divided into a first region and a second region based on a torque generated with a current that reaches the current rating of the plurality of third switching elements within a corresponding motor temperature range.
